(19) United States
(12) Patent Application Publication
(10) Pub. No.: US 2008/0302002 A1
(43) Pub. Date: Dec. 11, 2008

(54) Watering System for Watering Plants

(75) Inventor: Walter Schmidt, Russikon (CH)

Correspondence Address: RANKIN, HILL & CLARK LLP, 38210 Glenn Avenue, WILLOUGHBY, OH, 44094-7808, US

(73) Assignee: PLANTCARE AG, Russikon (CH)

(21) Appl. No.: 12/094,735

(22) PCT Filed: Aug. 11, 2006
(86) PCT No.: PCT/CH06/00426

§ 371 Date: Jun. 18, 2008

(30) Foreign Application Priority Data
Nov. 23, 2005 (CH) 1866/05

(51) Int. Cl. A01G 29/00; A01G 25/00; A01G 25/16

(52) U.S. Cl. 47/48.5; 47/79; 137/78.3

(57) ABSTRACT

The invention relates to a method and a device (30) for watering plants by means of an electronically operating control system. The substrate moisture is measured at time intervals, and the measured values of a plurality of measurements are stored. The measured values that have been stored are used to identify a trend in the moisture content of the substrate, and this trend is used to adjust a quantity of water to be applied. A number of measurement cycles taking place between two watering cycles is preferably used to readjust the quantity of water.

### BACKGROUND OF THE INVENTION

The invention lies in the field of irrigation systems for plants, in particular of automated systems, as are defined in the method, the device and the arrangement in the patent claims.

The requirement for automatically operating installations for irrigating balcony plants or terrace plants is constantly increasing, since on the one hand the occupants are absent more often over longer periods of time, and it is becoming increasingly difficult to find people who are willing to tend to the plants in the meanwhile. On the other hand, the balcony or the terrace is becoming more significant and being increasingly included into the sphere of the living environment. Moreover, the occupants themselves often do not have the time and also do not have the knowledge to tend to the plants in an optimal manner, and are conscious of the expensive potted plants dying due to becoming waterlogged, and also on account of dryness which is too harsh or too long.

Automatic operating irrigation systems for balcony plants and terrace plants have been on the market for some time, but have never really been able to assert themselves for several reasons.

Most of the known systems require a water connection, which is often not present, in particular on balconies. In many cases, an electrical connection is also required, which is likewise often not present.

An automatic system for irrigation in most cases is, moreover, based on a time switch, which may be programmed such that one waters during a settable time, at certain times. The influence of climatic conditions thereby is not taken into account, i.e. one waters on cold, overcast days or on rainy days, just as often and as much as on hot days.

Different ground humidity sensors have been developed, in order to achieve a certain adaptation to the current climatic conditions. Since these should be very inexpensive for mass applications, methods such as the tensiometer method for example, are applied, which however have their disadvantages, such as for example a porous measurement body which becomes blocked or calcifies very easily.

Most of the known irrigation systems use so-called drip irrigation, with which fine droplet nozzles are incorporated into a distribution hose, from which water drips for a predefined period of time. These fine droplet nozzles calcify very quickly, or even become blocked. This partly or completely reduces the water quantity, but in practice may not be recognized. Moreover, the distribution hoses must be laid on the surface, which is not very pleasant optically.

Terraces are mostly planted with different plants having different sizes and water requirements. Differentiated water dispensing is almost impossible, so that all plants are watered more or less to an equal extent. Plants, however, are living things which grow and require differing degrees of water and nutrients with time, or depending on the external conditions. The known systems are not in the position of adapting automatically to the slowly changing requirements of plants.

Amongst other things, for the reasons mentioned above, the so-called automatic irrigation systems have not yet found widespread use.

### BRIEF SUMMARY OF THE INVENTION

It is the object of the present invention to provide a method and a device for the automatic irrigation of plants, in particular of potted plants and tub plants, which avoids the disadvantages mentioned above and wherein the method is able to be carried out in an inexpensive manner and the device is able to be manufactured in an inexpensive manner.

The object is achieved by the method and the device as is defined in the patent claims.

The irrigation of plants, in particular potted plants and tub plants, but also garden plants and lawns, is effected by way of an electronically operating control system. The humidity of a substrate, in particular earth, clay, sand, swelling clay or mixtures thereof, is measured at preferably regular time intervals with a humidity sensor. These readings are stored and are evaluated towards a humidity development by way of a suitable evaluation algorithm. A trend which is evaluated in such a manner, is used for the control and readjustment of a water quantity to be watered.

In one embodiment of the invention, the number of measurement cycles, which take place between two watering procedures, is used for the control of the water quantity. Thereby, the time duration between two humidity measurements and a water quantity to be watered per watering procedure, may be fixed beforehand. If a humidity measurement of a humidity sensor introduced in the plant substrate lies below a set humidity threshold, then the watering procedure is activated. Otherwise, a further humidity measurement is carried out after the completion of the set time duration. If, now, the water requirement of a plant increases over time, e.g. days, weeks or months, then the watering procedures are activated more and more often. This trend is accordingly ascertained, and the water quantity to be watered per watering procedure is increased, preferably in set steps.

If, for example, control electronics in the control unit ascertain that again one must rewater after a few measurement cycles, then the watering quantity is automatically increased by a certain amount. This is done, preferably, for so long, until the time intervals between two watering cycles come to lie within a set bandwidth. If the control unit on the other hand ascertains that a very long time passes between two watering procedures, then this means that too much water is present in the earth, and the watering quantity may be automatically reduced by a certain amount. This is effected, preferably, again until the time interval between watering procedures lies within a defined bandwidth. Such a time interval may, for example, be determined and/or fixed by way of the number of humidity measurements.

A control with humidity threshold values has the advantage that water is only reapplied when the plant really needs it. For this reason, with a suitable setting of the humidity threshold values, a partial drying up of the earth occurs again and again, which is advantageous for the growth of the plant, since the roots also need to be supplied with oxygen. The control may be designed such that one rewaters already after a slight drying up. One may thus keep the humidity practically constant with regard to time. This however tends to be disadvantageous for many plants.

The method according to the invention also has the advantage that the first setting of the water quantity to be watered per watering cycle needs only to be determined in a rough manner. The control automatically adjusts the watering quantity, such than an optimum of the ground humidity and its temporal course is achieved. Moreover, the closed-loop control electronics also recognize when the plants grow and when they require more water with time. This is automatically readjusted. The watering quantity is also adapted to the effective consumption, also with longer lasting hot or rainy phases.

Preferably, an inexpensively manufacturable, reliable sensor is used for the device according to the invention, for the measurement of the humidity in plant substrates. Preferably, one uses a sensor as is described for example in the patent application with the application number PCT/CH2005/000663.

This is an inexpensively manufacturable sensor which may measure the water content of earth substrates of all types and with a high sensitivity. This sensor, based on a thermal measuring principle, may be used in order to provide a device reliably with information on the current humidity status of a substrate. If cooling curves are measured and used for determining the humidity, then these may be set very sensitively to regions to be measured.

The device according to the invention is preferably miniaturized by way of integrating all parts which are essential for an automatic irrigation, in the device. A device according to the invention thus preferably contains a control unit, and an operating panel/display panel, a pump, an electricity supply, as well as a humidity sensor and connections to a water reservoir. The individual components are preferably fastened to one another in a removable manner, and as with the connections, are preferably being designed in a fluid-tight manner, or accommodated for example in a water-tight housing.

The irrigation device is preferably designed such that it may be integrated into existing plant pots and plant tubs, as well as inserted externally into the plant pots.

It is possible to carry out various settings and for these to be displayed, via an operating and display panel. These settings, for example, are different threshold values for cooling times with a humidity sensor with thermal measurement methods, i.e. one may set threshold values of the ground humidity, in order, depending on the plant type, to select optimal conditions for plants which tend to like a wet environment, for those which like normal humidity, and for those which tend to like a dry environment.

Moreover, as a rule, it is a big difference as to whether a plant is located outdoors or indoors. With indoor applications, the humidity usually changes significantly more slowly than in outdoor regions. The sunshine and also the drying effect of the wind cause a significantly higher water consumption outdoors. This means that longer time duration between two measurements may be provided for indoor applications. This effects a significant saving of energy, and in the case of the use of batteries, extends their operational life. It is also known to the man skilled in the art, that room plants should be watered, when possible, at greater time intervals for example of several days, so that the earth again and again dries out sufficiently to absorb oxygen, by which means the plant growth is positively influenced.

For this reason a mode “indoor” and “outdoor” may be present via the operating and display panel. With such modes, on the one hand, a time duration between two humidity measurements is defined, and on the other hand also preferably the parameters of a readjustment are suitably adapted by way of this. Thus e.g. for the outdoor region, a time duration between two measurements of 1 hour may be selected, and in the indoor region one of 6 hours, since here the humidity changes relatively slowly. Moreover, a minimal interval between two watering procedures typically in the region of 3-7 days is optimal in the indoor region, whilst a minimal interval between two watering procedures may indeed lie between 2 and 5 hours in the outdoor region.

In the borderline case, with indoor applications, it may occur that a watering quantity is increased again and again. This may be the case with small plant pots, in which relatively large plants with a large water consumption are planted. The situation in which a minimally set time interval between two watering cycles is not reached may occur, whereby the regulation control would supply more and more water. This, however, may not be able to be absorbed by the small quantity of earth which is available in small plant pots. Excess water would spill over, preferably back into its supply region. In the extreme case, it may occur that stored water is permanently pumped around. This should be avoided. This may now be effected by way of the control automatically switching from an indoor mode to an outdoor mode after a certain number of consecutive watering procedures. The minimal interval between two watering cycles may be reduced, for example, to a few hours by way of this, and an overshoot of the closed-loop control is prevented by way of this.

Further values which may be set at the operating and display panel are the water quantity per watering procedure which may vary according to the plant, and with tub plants preferably in water quantities of 50 ml to 100 liters, in steps of for example 50 ml to 1 l, for example 100 ml or 250 ml. Initial values, maximal values and minimal values of the number of measurement cycles which may be carried out until a watering procedure, or—as mentioned in the preceding section—a maximal number of water increases with consecutively occurring watering procedures, may also be set via the operating panel.

The control unit may comprise further functions. For example, a control mechanism may be provided, which ascertains whether a water supply takes place, e.g. whether a throughput sensor or a valve responds. If the water supply does not take place, i.e. a throughput sensor does not respond, then one must assume that either water is no longer present in the supply container, or, however, that the water supply conduit is blocked. When ascertaining a non-response of a throughout sensor, an alarm is activated. This may be effected optically, for example, by way of an indication on a display, a flashing light, or also acoustically, for example by way of a peeping noise. The setting and monitoring of a critical lower threshold value of a charged condition e.g. of a battery, may also be effected via the device.

Preferably, such an alarm is indicated or communicated to the user with all error functions of the device. One possibility lies in integrating a data output for activating a telephone modem, a GSM modem, into control electronics. With the activation of an alarm, a corresponding electronic or short message (e-mail or SMS) may be sent to a previously defined receiver.

The device may also be provided with a thermostat which is integrated into the closed-loop control unit. If for example, a plant is accommodated in a mini conservatory, as described in the application CH 527/05, then the control unit, together with a suitable heating/cooling, is in the position of regulating the temperature within the plant enclosure to a certain settable value.

Several of the devices according to the invention may be assembled into an arrangement/assembly. The individual devices are then connected amongst one another, preferably in a manner such that the status of all devices may be inquired and individual settings may be made, via one or a single operating panel. Such an arrangement is preferably circuited and controlled in a manner such that only a single device is subjected to a watering procedure. The design for an electricity supply of an individual device is also essentially sufficient for a central electricity supply by way of this.

The device may also comprise a light sensor, e.g. a photocell. Light which is present, as the case may be, also its intensity, may be included in the humidity combinations or trend computations. Preferably, a humidity measurement is carried out at regular time intervals. However, with a light sensor, it is also possible to shift the watering device into a day/night operation, or generally to provide it with further constraints, e.g. non-operating times. For example, pump noises and water noises may be undesirable during the night. On the other hand, an irrigation of a lawn may be undesirable at certain daily times, since persons may be located on or in the vicinity of the lawn.

### BRIEF DESCRIPTION OF THE DRAWINGS

Exemplary, preferred embodiments of the irrigation system according to the invention are described in detail by way of the subsequent figures. Thereby, there are shown in:

FIG. 1 a schematic representation of the device according to the invention, including the sensor;

FIG. 2 one possible design of the device according to the invention, without sensor or water supply;

FIG. 3 a schematic representation of an irrigation installation;

FIG. 4 irrigation device with a separate water supply container;

FIG. 5 an irrigation device integrated into a plant pot.

### DETAILED DESCRIPTION OF THE INVENTION

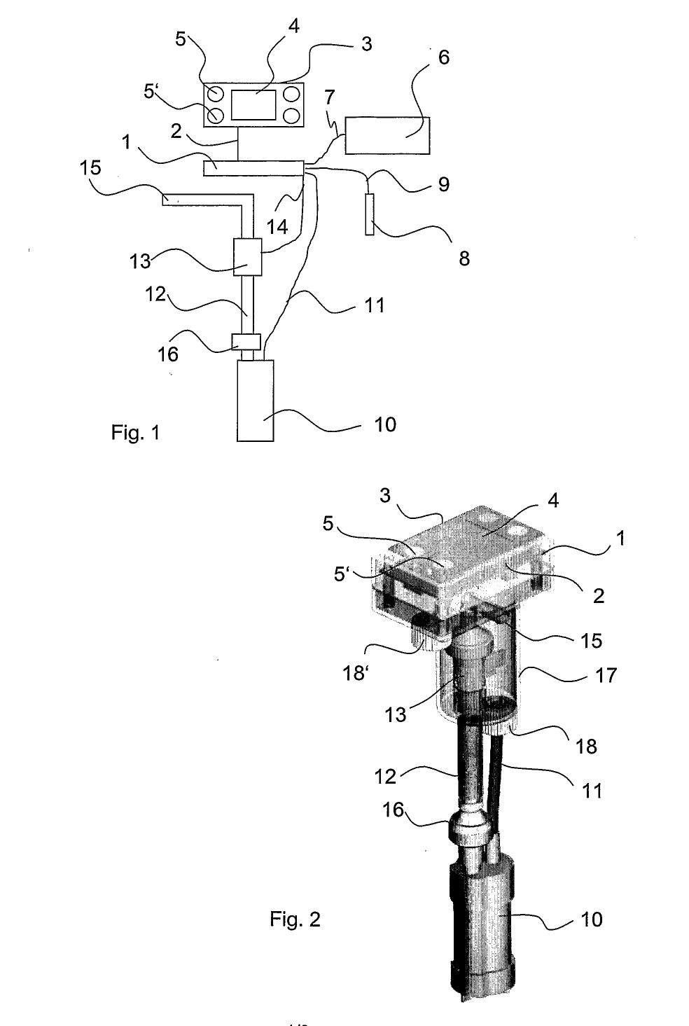

In FIG. 1, control electronics 1 are connected to an operating panel 3 by way of electrical connections 2. This panel contains a display 4 and operating elements 5, 5′. An electricity supply 6, for example in the form of a battery, a solar panel, possibly with a charging apparatus and an intermediate storage battery or a mains apparatus, is connected to the control electronics by way of a cable 7. The ground humidity sensor 8 is likewise connected to the control electronics with a further cable 9.

A submersible pump 10, provided with a return valve 16 which may be activated by the control electronics by way of a cable 11, is connected via a hose 12 to an electronic throughput sensor 13, a water throughput meter, which in turn transmits its signals to the control electronics 1 via a further connection 14. A hose 15, which leads away from the submersible pump and the device, permits the distribution of the water delivered by the submersible pump.

The control electronics may be provided with software which automatically carries out readjustments of the water quantity per watering procedure, on the basis of history values. Initially set values, thus, do not need to be very accurate, since the control system permits a readjustment with regard to the frequency and quantity of the water to be supplied to the plant.

Thus, all or certain of the following values are set with a newly installed irrigation device: humidity threshold, watering quantities, a minimal number of measurement cycles until one waters, a maximal number of measurement cycles until one waters.

If now, for example, a minimal value of four measurement cycles and a maximal value of 16 measurement cycles are set, then the water quantity per watering procedure is increased as soon as a lower humidity threshold value is reached or fallen short off, already after 1, 2 or 3 effected humidity measurements. If now a lower humidity threshold value is not reached also after 16 measurement cycles, this means that the substrate has too much moisture and the watering quantity is, preferably, automatically reduced.

It is also possible, for example, to use the absolute humidity details for a trend evaluation, thus, for example, the speed at which the humidity in the substrate between two or more measurement cycles changes. Upper humidity thresholds may also be set, and the attainment of this threshold, or the frequency of the attainment of the threshold over several measurement cycles, may be used for readjusting the water quantity.

Differently set, settable and measured details, e.g. also the current ground humidity, may be displayed on the display 4, for example in the form of a moving dial or in the form of numbers, so that a tender always has the possibility of controlling the condition within the plant pot.

One further possibility is the integration of various control functions and alarms, for example a water alarm and/or frost alarm. The initially mentioned humidity sensor, which is preferably used, measures the current temperature of the surroundings anyway. If this sinks below a critical value, then this may be displayed by a corresponding signal on the display and/or optically or acoustically in a different manner. The tender may carry out suitable measures for protecting the plant from temperatures which are too low.

FIG. 2 shows a preferred embodiment of the irrigation device, wherein the same reference numerals have been used for the same elements. The electricity supply, as well as the ground humidity sensor, are not represented. Apart from the already mentioned elements, one recognizes a housing 17 which is closed in a water-tight manner and which encloses all electronic components. The cables are preferably led to the outside to the electricity supply, the sensor and the submersible pump, through water-tight cable lead-throughs 18, 18′.

The dimensions of the operating panel typically lie in a range of a few centimeters, preferably 4 to 12 cm, for example 5-10 cm, e.g. 6 cm. The length of the hose connection and cable connection to the submersible pump may vary, and lies in a preferred range of 5 cm to 2 meters, for example between 5 cm and 1 meter, e.g. 15-25 cm. In order to obtain the most from the device—with regard to energy technology and irrigation technology—the length of the hoses should be adapted to the pump power of the pump and vice versa. Generally, the device is preferably designed in a compact manner and in a manner such that it may also be introduced into commercial plant pots in the household and balcony, e.g. balcony boxes.

The procedure of the control according to the invention may be described as follows in a preferred embodiment:

In certain selectable time intervals, preferably between 0.5-5 hours, e.g. every 1-3 hours, the humidity sensor 8 which operates as a humidity sensor with a thermal measurement method operated in a pulsed manner, is heated with a, preferably, precisely defined energy impulse by way of the activation electronics 1 for a brief time, i.e. a few seconds, e.g. 2-5 s, and the cooling curve is subsequently plotted. A cooling time is determined from this, and is compared to a settable threshold value. If the measured time lies below the threshold time, then no action is activated. If however it lies higher, then the pump is activated. This is activated until the throughput sensor 13 measures a settable value. Thereupon, the pump is switched off again. This procedure is repeated in the time intervals mentioned above. All procedures are preferably effected automatically and in an electronic manner.

If it then results that the water requirement of the plant changes, for example due to growth, more sunshine, etc., then the closed-loop control unit recognizes that one needs to water more often than a previously set frequency. The control unit, thus, automatically increases the water quantity per watering procedure. The frequency is, preferably, a number of implemented measurement cycles or also a time elapsed since a last watering procedure. A number of the increases of the water quantity with consecutive watering procedures is preferably limited to the top. If a maximal number of increases on account of the measured humidity again demands a water increase, then instead of a water increase, one preferably changes to a greater watering frequency (indoor/outdoor-mode). Then, by way of this, one may prevent quantities of water from being dispensed with a watering procedure which are larger than may be accommodated by a pot.

The individual steps are preferably all monitored and controlled by the control electronics. Of course, it is also possible for individual steps such as for example a rewatering or an increase/reduction in the water quantity to be displayed, but to be carried out by hand.

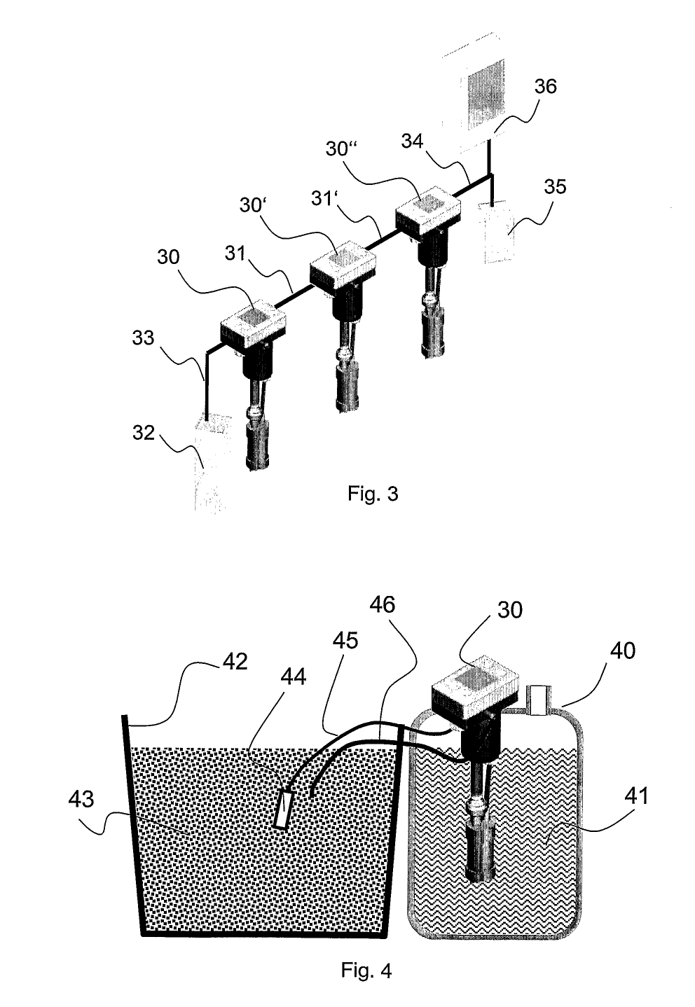

A further very useful supplementation of the scope of the function of a control unit lies in the possibility of coupling two or more irrigation units to one another, e.g. by way of a digital bus. This configuration is shown schematically in FIG. 3. The irrigation installations 30, 30′ and 30″ are connected to one another by way of cables 31, 31′. The cable has a digital bus, but also an electricity supply which is connected to an electricity supply unit 32 by way of a further cable 33. A GSM modem 35 is connected by way of cable 34 at the end of the basically infinitely long chain of irrigation installations. Moreover, a central unit 36 for representing and the control of all connected installations is connected. This permits a control of a e.g. large, widely branched installation, by way of a favorably situated central unit. Moreover, only one individual operating and display unit is required on account of this.

Such a configuration e.g. permits the optimisation of the central electricity supply, since the simultaneous response of the pump of two or more installations may be controlled and prevented. The electricity supply may be designed purely with regard to the loading of a pump by way of this. A digital bus also permits the notification of the tender by way of a single GSM modem, since all information, in particular alarms, of all connected installations may be tapped at a single output.

The irrigation installation according to the invention is designed such that it may be integrated into existing plant pots as well also maybe applied externally by the plant pots.

FIG. 4 shows a configuration with which the miniaturized irrigation device 30 is integrated into a separate water supply container 40 and from there serves a plant pot 42 with earth 43 via a water distribution hose 46. This configuration is particularly suitable e.g. if one only periodically requires an automatic irrigation, e.g. during a longer absence. One advantage of this arrangement lies in the fact that the water supply container may be practically infinitely large, so that long absences may be bridged. Moreover, such a container is cheap and may be placed everywhere.

The disadvantage is that the cable 45 to the sensor 44 as well as the water hose 46 are visible, wherein this disadvantage is not so important with a temporary absence.

If a water storage container is arranged above pot level, then, as the case may be, one may make do without a pump. The control unit, thus, only controls an opening and closure of a valve for the supply of water.

The water distribution hose may also be divided into several branches, so that several plant pots—advantageously with a similar size and planting type—may be supplied with water.

Plant additions, such as fertilizers, may be directly added into the water supply container.

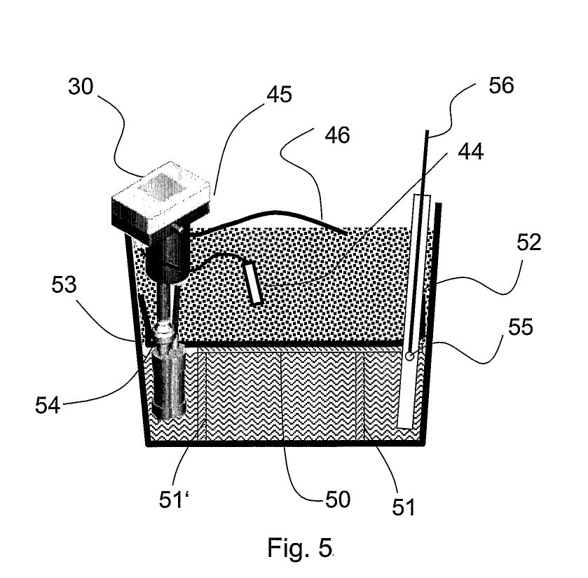

FIG. 5 shows a solution with which the irrigation installation is integrated completely into a plant pot. Thereby, a volume is separated by spacers 51, 51′ and an intermediate plate 50, and this volume may be used as a water supply volume. The irrigation device may be inserted through a recess 54 in the intermediate plate 50 from above, so that the submersible pump may be submerged as deeply as possible into the supply water. A layer of a water-permeable non-woven 53 with a recess, prevents earth getting into the water from the top.

A tube 52 which is likewise inserted through a recess in the intermediate plate serves for filling the water supply. A floating body 55 with a scale 56 which serves as a filling level indicator may also be introduced into this tube.

If the arrangement is operated by way of batteries or rechargeable batteries, then these may likewise be accommodated in a water-tight tubular battery casing, in the plant pot, wherein the batteries in this case are exposed to the very uniform temperature of the surrounding earth, which increases the life duration of the batteries.

Of course the submersible pump may also be replaced by a pump which is located outside the water supply. Moreover, it is possible to replace the pump with a magnet valve controlled by control electronics, so that the water may be taken directly from the water mains.

1.-23. (canceled)

24. A method for irrigating plants by way of an electronically functioning control system, comprising the steps of:
measuring substrate humidity in time intervals,
storing measurement readings of a plurality of measurements, and
deriving a humidity trend of the substrate with the stored measurement readings, the humidity trend being used for the readjustment of a water quantity to be watered.

25. A method according to claim 24, wherein a number of measurement cycles between two watering procedures is used for readjustment of the water quantity.

26. A method according to claim 25, wherein the water quantity is increased, with a number of measurement cycles between two watering procedures, which number of measurement cycles is smaller than a predefined number of measurement cycles.

27. A method according to claim 25, wherein the water quantity is reduced, with a number of measurement cycles between two watering procedures, which number of measurement cycles is larger than a predefined number of measurement cycles.

28. A method according to claim 26, wherein the water quantity is reduced, with a number of measurement cycles between two watering procedures, which number of measurement cycles is larger than a predefined number of measurement cycles.

29. A method according to claim 24, further comprising a first and a second measurement mode, which differ at least by a different, minimal time interval between two consecutive watering procedures, and wherein one goes over from the first measurement mode to the second measurement mode, as soon as a predefined number of increases of the water quantity is exceeded.

30. A method according to claim 24, wherein a frequency of a watering cycle is increased on exceeding a predefined number of increases of the water quantity with consecutive watering cycles.

31. A method according to claim 24, wherein the water quantity to be watered is determined over a watering time.

32. A method according to claim 24, wherein a computed water quantity is measured by an electronically functioning throughput sensor.

33. A method according to claim 32, wherein an alarm, in particular an optical or acoustic alarm, is activated with a non-response of the throughput sensor.

34. A method according to claim 24, wherein a communication is sent to a user with a faulty behaviour of the control system, in particular with a non-response of a throughput sensor.

35. A device for the automatic irrigation of plants comprising:
an earth humidity sensor;
an electronic control circuit, with which signals of the earth humidity sensor may be received; and
a means for the control of a water supply, the means being connected to the control circuit, wherein the control circuit contains a data memory, in which measurement readings may be recorded over a certain time period, and the control circuit contains evaluation electronics, with which a trend of the measurement readings may be ascertained and may be used for a correction of a water quantity to be watered, by way of an activation of the means for the control of a water supply, in accordance with the trend.

36. A device according to claim 35, wherein the means for the control of a water supply contains a water throughput meter and a set-up for switching the water flow on and off.

37. A device according to claim 35, further comprising an operating panel via which at least one of the following may be set:
different threshold values for a critical dryness of different plant types;
a water quantity to be watered per watering cycle; and
different measurement modes with differently set watering frequencies.

38. A device according to claim 35, wherein an operating panel contains at least one of the following:
a display of a current ground humidity;
a display of the function of the means for the control of a water supply; and
a display of a charged condition with battery operation of the device.

39. A device according to claim 38, wherein at least one display is an alarm display with which an alarm may be activated given at least one of the following:
a non-response of a throughput sensor during a watering procedure;
on reaching a lower threshold of a charging condition of a battery.

40. A device according to claim 35, further comprising a temperature sensor for the control of a heating/cooling of a conservatory to be brought over a plant.

41. A device according to claim 35, further comprising a telephone modem connected thereto, for sending alarm communications.

42. A device according to claim 35, further comprising a submersible pump for producing a water flow which is necessary for a watering procedure, the pump being able to be activated by the control circuit.

43. A device for the automatic irrigation of plants comprising:
an earth humidity sensor;
an electronic control circuit, with which signals of the earth humidity sensor may be received; and
a means for the control of a water supply, containing a water throughput meter and a set-up for switching the water flow on and off, the means being connected to the control circuit,
wherein the control circuit contains a data memory, in which measurement readings may be recorded over a certain time period,
wherein the control circuit contains evaluation electronics, with which a trend of the measurement readings may be ascertained and may be used for a correction of a water quantity to be watered, by way of an activation of the means for the control of a water supply, in accordance with the trend, and
wherein the device further includes a submersible pump for producing a water flow which is necessary for a watering procedure, the pump being able to be activated by the control circuit.

44. A device according to claim 42, wherein a magnet valve may be activated, and releases or stops the water flow from an external water supply, the water flow being necessary for the watering procedure.

45. An arrangement with a plurality of devices according to claim 35, wherein the plurality of devices are connected to one another via signal connections.

46. An arrangement according to claim 45, wherein information on the momentary status of an individual device may be inquired from each of the connected devices via the signal connection.

47. An arrangement according to claim 45, wherein maximally a single device is situated in a watering cycle.

48. An arrangement according to claim 45, wherein the signal connection is connected to a central display for displaying the current status of all devices.
